(19) United States
(12) Patent Application Publication
(10) Pub. No.: US 2005/0246343 A1
(43) Pub. Date: Nov. 3, 2005

(54) Network management system permitting remote management of systems by users with limited skills

(75) Inventors: Raymond S. Burns, Newton Centre, MA (US); Joan M. Friedman, Waltham, MA (US)

Correspondence Address: GORDON E NELSON;PATENT ATTORNEY, PC, 57 CENTRAL ST, PO BOX 782, ROWLEY, MA, 01969, US

(73) Assignee: Nantasket Software, Inc

(21) Appl. No.: 10/816,290

(22) Filed: Apr. 1, 2004

Related U.S. Application Data
(60) Provisional application No. 60/470,753, filed on May 15, 2003.

(51) Int. Cl. G06F 17/30

(52) U.S. Cl. 707/10

(57) ABSTRACT

A method and system to establish and delegate control of client-server computer systems over a wireless network according to policies established dynamically by an authority. In particular, one embodiment of the present invention includes a system to specify and promulgate user and command profiles that constrain wireless handsets to execution of commands specified in said user and command profiles, to specify and execute general-purpose computer commands to computers that are nodes in distributed networks or sub networks from a wireless device together with a method and system to monitor the status of specified computer services and specified computers and alert the wireless device user to exceptional conditions.

### TECHNICAL FIELD AND BACKGROUND ART

The present invention relates to resolving computer network service interruptions. As organizations continue to build their businesses upon computer networks, network and services maintenance becomes increasingly important. Occasionally computer services required by customers or general employees behave unexpectedly or become non-responsive, interrupting those services. Interrupted service costs are in direct proportion to the value of the service and the duration of service interruption: the more valuable the service and the longer the service interruption, the greater the cost to the organization providing the service. Customers may leave a non-responsive service for a competitor's service and organization employees may be idled or switch to lower-priority tasks while waiting for service restoration. The problem is how to restore services in the shortest time possible and to address the underlying problem that caused the service interruption to prevent a recurrence.

Organizations recognize the value of services provided by their computer networks and the cost of service interruptions and vest responsibility for the organization's network resources in an executive officer, the Chief Information Officer (CIO). A staff of technically trained Systems Administrators (SA) may assist the CIO in establishing and maintaining the organization's computer networks according to CIO policies. An organization usually provides External services to customers and business partners and Internal services to employees. Internal services provided by networked computers are increasingly required for general employees (not technically qualified or authorized in computer administration) to carry out their business functions. The CIO is responsible for monitoring the availability of External services and dispatching an SA to resolve External Service Interruptions. In case of an Internal Service Interruption, affected users typically call the “Help Desk”, a dispatch function under the CIO, to dispatch an SA to resolve the Service Interruption.

Economic forces have reduced computer network maintenance budgets (and staffing) at the same time that business reliance on computer networks has increased significantly. As a direct result, a shrinking staff of SA's must resolve Service Interruptions of increasing importance and SA's may be unable to resolve all Service Interruptions before significant costs are incurred.

Computers in a network that behave unexpectedly or become non-responsive are termed Problem Nodes in this document (See Glossary section in Detailed Description, below). In these terms, the problem question may be stated as: how to detect and resolve Problem Nodes before significant costs are incurred?

It is known in the prior art that Problem Nodes may be resolved in three basic ways:

Solution 1) An SA physically travels to the Problem Node and re-starts services or the computer locally. This solution resolves Problem Nodes reliably but is expensive in terms of SA time and opportunity costs (an SA cannot respond to other Problem Nodes while in transit). The costs are only justifiable by comparison; Service Interruptions are generally much more expensive than an SA wasting productive time traveling to and from a Problem Node unless the Problem Node is physically distant. Other disadvantages of this solution are is that a) the method cannot be delegated—only an SA can resolve the Problem Node in this way and b), no audit trail is generated (other than the SA's memory) for later Problem Node analysis and repair.

Solution 2) Remote (or automatic) power-reset device over a secure network connection: This solution also resolves Problem Nodes reliably and much more quickly than Solution 1). The disadvantages are a) the initial capital investment (usually at least 20-30% of the cost of each Node), b) the method cannot be delegated—only an SA can access the device to resolve the Problem Node, c) device access interfaces are normally limited to desktop or laptop computer Nodes, making 24/7 coverage inconvenient, and d) indiscriminate or automatic power resets generate no audit trail for later Problem Node analysis and repair.

Solution 3) Remote computer control over a secure network: this solution also resolves Problem Nodes reliably and often more quickly than Solutions 1 and 2). At the high end, IBM's Tivoli, HP's OpenView and CA's Unicenter provide complete and reliable network management controls across an enterprise. The main disadvantage of this solution is the substantial initial capital investment. Remote Control software packages in the Mid to Low priced range are far less costly than high-end Network Management packages, but are considerably less reliable than enterprise network management products because these products require that both the Problem Node and a Control Node must have the same software package installed with compatible security options enabled in order to function. As these low-end products provide no means of ensuring that compatible versions Remote Control software are installed on all Nodes providing services to customers and/or employees, an SA cannot rely on establishing a connection to the Problem Node to restore its services using a Remote Control product. Also, these low-end products provide no means of monitoring services or notification of failures; they are designed specifically to control a Node from another Node. b) Low-end products have no means of controlling delegation—only an SA can resolve the Problem Node in this way, c) network management access interfaces are normally limited to desktop or laptop computers, making 24/7 coverage inconvenient and d) network management systems generate no audit trail for later Problem Node analysis and repair.

Therefore, there exists a need to provide more convenient, secure, delegate-able and cost-effective means to monitor Nodes for problems, notify specified users of problem events, and restore Problem Nodes to responsiveness while leaving an audit trail, than the solutions known in the prior art and discussed above.

### SUMMARY OF THE INVENTION

A system for allowing control of a remote computer using a wireless device is disclosed. The system includes an input for receiving a signal originating from a wireless device. The signal from the wireless device includes identification information. The system further includes a database containing user profile information that is associated with the identification information. The signal from the wireless device is received by a remote computer from the input. The remote computer responds to the initial signal from the wireless device containing the identification information and the remote computer locates user profile information corresponding to the identification information in the database. The remote computer then sends one or more control templates to the wireless device that are dependent on the user profile information. The user may then control applications on the remote server as provided for in the user profile and the remote computer will provide additional templates that are determined by the user profile information. In an embodiment of the invention, a method is provided to maintain maximum network resource availability with a minimum of time, investment and effort on the part of the CIO and his/her staff. Various embodiments of the present invention can increase the effectiveness and reduce the workload of computer support staff charged with resolving Problem Nodes without compromising network security or operating policies. The computer support function in many organizations faces reduced budgets and reduced staff yet the same or increased responsibilities to maintain organizational networks and services. Wireless Network Management Systems (WNMS) exist as available products or sub-configurations of existing products, but their use cannot generally be delegated to untrained affected parties (AP)s without compromising network security or access policies. The first embodiment of the invention will be referred to herein as an Intelligent Wireless Network Management System (IWNMS) to distinguish it from ordinary WNMSs described in prior art. The IWMNS adds significant functions not found in existing WNMSs through the use of databases to a) provide a practical means of delegating control of specified Nodes to non-SA individuals within constraints defined by an SA, b) retain an audit trail of selected commands issued and their responses and c) provide a two-way communications medium between User Handsets and an Administrator Console. FIG. 3 illustrates an IWNMS demonstrating a method of effectively delegating authority and control of specified Nodes to an AP who may not be trained or authorized as an SA. In the IWNMS, an AP can exercise limited control of specified Nodes under the control and supervision of an SA, solving a pervasive problem that, by common CIO policy, presently constrains control of Nodes to SA's only. To date, CIO policies have prohibited delegation to untrained APs because there was no way to prevent inadvertent damage to the network infrastructure, since untrained APs would be “out of control” and could inadvertently cause great harm to the network. With an IWNMS, untrained APs can pick up duties normally reserved to SAs because their actions remain under the control of an SA. The AP may be an employee in a departmental or smaller enterprise management role that the CIO or SA can personally trust with limited control of specific computer resources that may directly affect the AP's ability to perform his/her job. In operation, an SA configures a User Handset 1 and Managed Computers 3 with an individualized User Profile for the AP. In an IWNMS, an SA, authorized by the CIO, may delegate his/her authority to an AP to control Nodes and services and to issue Commands specified in a User Profile. The SA defines the User Profile (commands, Nodes, services) in the Global Database 4. The User Profile may include a User Handset identification number, password, User Handset enabled/disabled status, command names and parameters. An SA or CIO may change the User Profile at any time from the Administrator's Console 7. The SA communicates the AP's assigned password to the AP in confidence, completing the delegation of authority to the AP.

At some point, the AP may receive an Exception Notification on the User Handset or the AP may decide (asynchronously) to issue control commands to one of the Managed Computers 3, 5 specified in the User Profile. Prior to executing control commands, the IWNMS service in the Managed Computer downloads the current User Profile from the Global Database to govern the behavior of the User Handset. This dynamic Profile loading allows a CIO to delegate computer system control authority without breaching network operations policy even if that policy changes once control is delegated. In an IWNMS, each Control Command issued by the User Handset 1 and each Control Command response status is retained in the Global Database 4 as an audit trail for future analysis and to aid in solving the underlying problem that caused the Problem Node.

### BRIEF DESCRIPTION OF THE DRAWINGS

The foregoing features of the invention will be more readily understood by reference to the following detailed description, taken with reference to the accompanying drawings, in which:

FIG. 1 is a system block diagram illustrating the primary components of a Wireless Network Management System (WNMS).

FIG. 2 illustrates a WAP WNMS Diagram depicting an alternate WAP infrastructure Components in relationship to other components.

FIG. 2A illustrates a technique of adding a wireless interface to a network management system whose primary interface is a wired interface.

FIG. 3 is a system diagram of one embodiment of an IWNMS and its relationship to a WNMS.

FIG. 4 is a system block diagram of one embodiment of the IWNMS detailing the portion resident within a single Managed Computer.

FIG. 5 is a screen shot of one embodiment of the 5-button User Handset interface of the IWNMS. FIG. 5 illustrates the Test Command user interface (left) and the Test Command response (right).

FIG. 6 is a screen shot of one embodiment of the Configure Command user interface (left) and the Configure Command Response (right) of the IWNMS.

FIG. 7 is a flow chart illustrating one embodiment of the operation of the IWNMS.

### DETAILED DESCRIPTION OF SPECIFIED EMBODIMENTS

Definitions. As used in this description and the accompanying claims, the following terms shall have the meanings indicated, unless the context otherwise requires:
Administrator (SA): Alternately, Systems Administrator or Network Administrator.
Skilled technician trained in computer and network operations and authorized by the CIO to control general user access to Managed Computers and to perform computer network operations within organizational policies.
Administrator Handset: A user handset with a specific User and Command profile set for an Administrator's use. Receives all Event Notifications.
Alert: Console or User Handset status indicating receipt of an Exception Notification event.
Application Level (layer): the highest and most common of network communications protocols. See the OSI model of networking, composed of layers or levels. OSI defines a 7-layer protocol stack, in which each stack layer provides limited functionality to the layer above. Nearly all user requests resolve to Application Level network messages.
Audit Trail: Sequence of User Handset Commands, Command parameters and/or Command results retained in the Global Database and visible from the Administrator's console.
Authenticated User: A handset user who entered the correct handset password in less than the maximum number of retries defined by an SA. See User Authentication.
Carrier Network: telecommunications network where communications between local or distributed nodes using standard wireless, wired and computer telephony protocols. An example is the cellular telephone network provided by Wireless Service Providers (WSPs) that supports WAP and public, and carrier-proprietary security protocols.
CIO: an individual responsible for computing resources and staff, and formulating and enforcing computer resource usage policies for an organization (e.g., commercial, governmental or non-profit) regardless of organization size. In particular, the CIO and SA may be the same person.
Client-server System: a computer and remote resources (possibly other computers or computer networks) connected over a Communications Channel.
Command Profile: a collection of data items associated with a User Profile consisting of a set of commands the user is authorized to invoke.
Communications Channel: a network such as a local or wide area network, telecommunications network or an instance of other types of data communications network that functions using communications protocols.
Compatible Operating Systems: Any computer operating system supported by the present invention, including but not limited to: Microsoft Windows XP, 2000, NT 4.0, Linux, Unix, Macintosh (OSX), Netware, HP-UX, Sun Solaris, Novell Netware, IBM AIX and OS390.
Configured Service: a computer service chosen by the Administrator during invention installation or administration as eligible for control by one or more User Handsets.
Distributed Computer Network: computer network containing component networks implemented with incompatible protocols. Protocol translation may be required between component networks; protocol translation between component networks at specific network levels is typically implemented with Gateways. An example is a network conjoining the Internet and Carrier Networks; both networks use the Transmission Control Protocol/Internet Protocol (TCP/IP) protocol suite, but require protocol translation at the application level to translate Wireless Application Protocol messages into HTTP/HTTPS messages.
Distributed Wireless Network: a conjoined Carrier Network and Distributed Computer Network in which the interface between a Carrier Network and a Distributed Computer Network is a Gateway.
Exception: a condition in which a Managed Computer or one or more Configured Services behaves unexpectedly.
Gateway: a protocol translation device that facilitates bi-directional communications between Nodes on different networks, such as Nodes on a Carrier Network and Nodes on an IP Network.
Health Test: A test of one or more Configured Services or Configured Server/Computers to determine the approximate likelihood of response if the Configured Service or Configured Server were to receive a request.
IP Network: the Internet or any other computer network implemented with Internet protocols.
Managed Computer: any computer with the invention installed that employs a Compatible Operating System and has a persistent connection to the Internet. Communications with a Managed Computer means communications with an instance of the invention installed on a Managed Computer.
Network Management Node (NMN): See Node.
Network Management System: a computer network monitoring and control system in which a network monitoring and control device may receive Exception Notifications from network Nodes and/or the network monitoring and control device may issue asynchronous commands to a Node for execution by the Node.

Network User (AP): A computer user, who may or may not be skilled in network operations, is not normally authorized to perform any computer network operations, but uses one or more computers on the Distributed Wireless Network to perform their normal daily duties.
Node: a User Handset or a Computer connected within a Distributed Computer Network of similar devices.
Problem Node: a Node that fails to respond or responds erroneously to Application Level requests from other Nodes.
Remote Reset Device: one of a class of hardware devices that control power to a computer through a remote connection (e.g., Internet or telecommunications network).
Session: Sequence of invention Control Commands to a Managed Computer beginning with User Authentication and ending with disconnection from a communications network.
User Handset: component of a licensed IWNMS: any handheld wireless communications device that supports “browsing” the Internet. An example of a user handset is a common WAP cellphone, a Java-enabled cellphone, a Personal Digital Assistant (PDA) or other handheld, low-power wireless communications or computer devices.
User Authentication: procedure designed to restrict access to network resources to authorized users. See Authenticated User.
User Status: a collection of data items associated with a wireless handset user that may list the commands invoked and the results obtained during a user Session. The User Profile may contain a reference identifying a handset User Profile as well as other data items.
User Profile: a collection of data items associated with a wireless handset user. The User Profile may contain a reference identifying a Managed Computer license as well as other data items.
WAP Gateway: a Gateway that translates WAP formatted messages (WTLS protocol) into HTTP or HTTPS messages and vice-versa.
Wireless Network Management System: a Network Management System in which the primary hardware interface to the Network Management System is a wireless device, computer system monitoring and control information is exchanged over a wireless communications channel connecting managed computers and the primary hardware interface.

It should be noted that although the embodiment of the invention that is described is with respect to a networked system that is managed by a CIO and SAs, the invention may be applicable to individual computers having an Internet connection that are controlled by a wireless device.

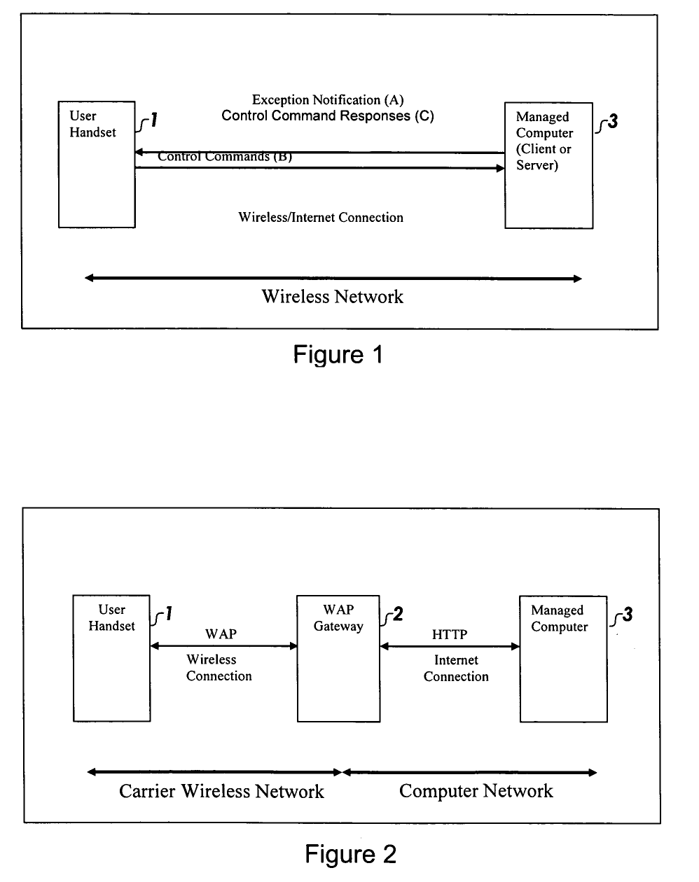

As illustrated in FIG. 1, Exception Notifications and Control Commands are shown as separate unidirectional arrows for clarity. In IWNMS, Exception Notifications (A) and Control Commands (B) are communicated using different protocols. Although the IWNMS uses SMTP/SMS for Exception Notifications, other protocol combinations (such as WAP Push and others) could be used as well. Also, Exception Notifications (A) and Control Command Results (C) may be communicated using different protocols. Although the IWNMS uses HTTP/XML, other protocol combinations (such as WAP/WML) could be used as well.

A single double-headed arrow is used in Figures hereinafter to denote bi-directional wireless communications between WNMS and IWNMS components regardless of the particular protocols employed.

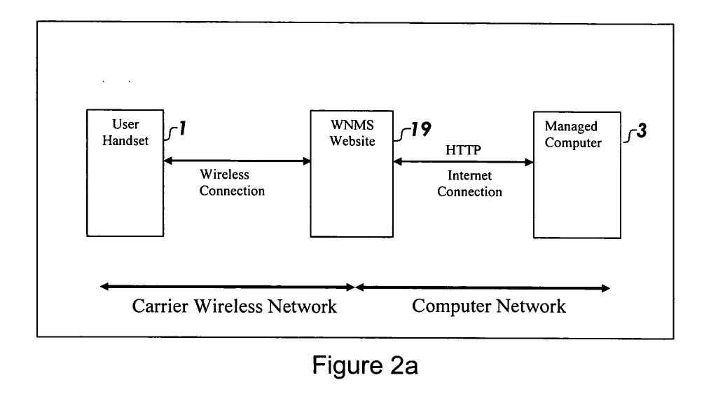

FIG. 1 is a system block diagram illustrating the primary components of a Wireless Network Management System (WNMS). As shown in FIG. 1, a User Handset 1 is in bi-directional wireless communications with a Managed Computer 3 over a wireless network provided by a Wireless Service Provider (WSP). FIG. 1 illustrates direct communication between a User Handset and a Managed Computer; communications do not pass through an intermediary, such as the Wireless Application Protocol (WAP) requires. (See FIG. 2, and the discussion of WAP below). In an IWNMS, an IWNMS component in the Managed Computer 3 notifies the User Handset 1 that an Exception occurred in one or more Configured Services or in a Configured Computer. In response, the authorized user (AP) in possession of the User Handset 1 may select a Managed Computer 3 URL in the User Handset browser. Selection of the Managed Computer URL establishes a secure connection from the User Handset 1 to an IWNMS instance on the Managed Computer 3 and displays a User Authentication prompt for the handset password. The Administrator designated the handset password during IWNMS installation or subsequent IWNMS administration from the Administrator console and gave it to the AP in confidence. On entering the correct handset password, the AP may select from dynamically authorized commands specified in a User Profile to address the exception.

FIG. 2 illustrates a WAP WNMS Diagram depicting an alternate WAP infrastructure Components in relationship to other components. As illustrated in FIG. 2, WAP communications between a User Handset 1 and a Managed Computer 3 pass through an intermediary WAP Gateway 2. All communications described in reference to FIG. 1, above, occur in a WAP WNMS unchanged except that said communications pass through an intermediary WAP gateway. Consequently, outbound communications from a Managed Computer to the User Handset must comply with the WAP protocol. The indirection adds time delays and a certain degree of unreliability, since the intermediary as well as the User Handset and the Managed Computer must be functioning for communications to occur.

FIG. 2A illustrates a technique of adding a wireless interface to a network management system whose primary interface is a wired interface. A website is created and installed on a wired server that displays static HTML screens with active components for enabled commands. A wireless user selects an enabled component which performs the selected command through the Network Management System standard wired interface, which returns command results to the proprietary website for return to the User Handset. The indirection adds time delays and a certain degree of unreliability, since the intermediary as well as the User Handset and the Managed Computer must be functioning for communications to occur.

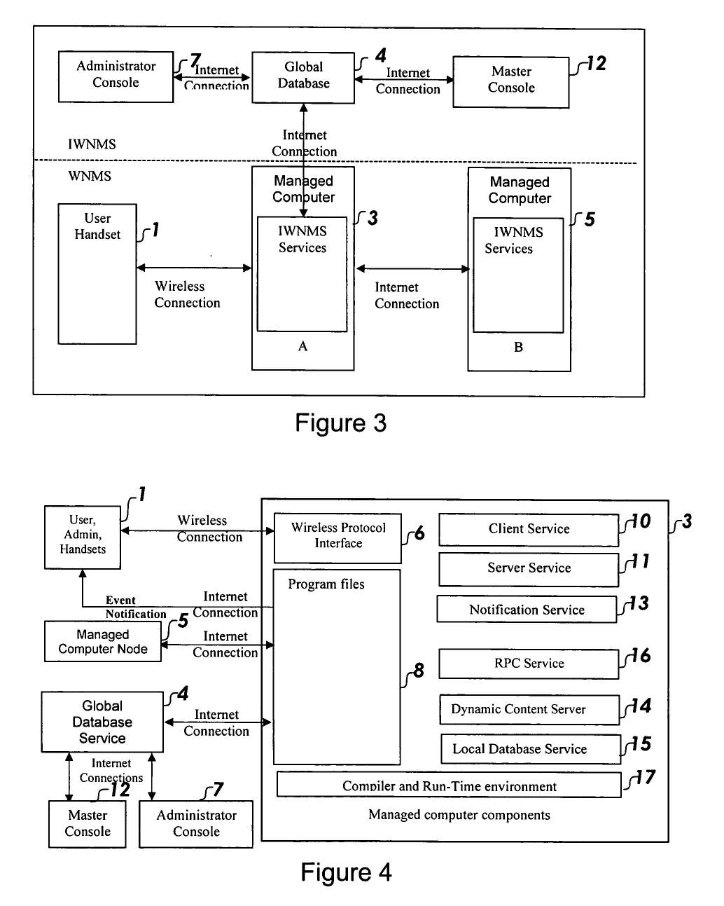

FIG. 3 is a system diagram of an IWNMS and its relationship to a WNMS. The dotted line in FIG. 3 shows the relationship between a conventional WNMS and an IWNMS; IWNMS capabilities are a superset of WNMS capabilities. Although not exact, the dotted line indicates the limits of a WNMS. FIG. 3 illustrates the relationships between the IWNMS (or WNMS) services resident in each managed computer 3, 5, the User Handset 1, and Global Database 4. The Wireless Connection between the User Handset 1 and a Managed Computer 3 carries Exception Notifications and Control Commands responses from the Managed Computer 3 to the User Handset 1 and Control Commands from the User Handset 1 to the Managed Computer 3. In FIG. 1, User, Admin, Handsets 1 shows a single box for two distinct but similar devices: Both the User Handset and the Admin. Handsets receive the same Event Notifications; they differ only in that they have different User Profiles. For illustrative purposes, FIG. 3 identifies the network connections between the several components of the IWNMS as “Internet Connection” and “Wireless Connection”. The “Internet Connection” label does not imply that the labeled network connection must use Internet protocols. Other protocols may be used as well, such as X.25, HDLC, PPP, FDDI, and Token Ring (802.5) to name a few. The Internet Connection between the Managed Computer 3 and another Managed Computer 5 carries Control Commands from the Managed Computer 3 to another Managed Computer 5 and Command Results from Managed Computer 5 to Managed Computer 3. For illustrative purposes, the Internet Connection between the Managed Computer 3 and the Global Database 4 carries User Profiles from the Global Database 4 to the Managed Computer 3 and User Status from the Managed Computer 3 to the Global Database 4. The Internet Connection between the Administrator and Master Consoles 7, 12 and the Global Database 4 carries User Profiles from the Administrator and Master Consoles 7, 12 to the Global Database 4 and User Status from the Global Database 4 to the Administrator and Master Consoles 7, 12.

FIG. 4 is a system block diagram of the IWNMS detailing the portion resident within a single Managed Computer: Individual components are summarily discussed below with reference to FIG. 4:

Global Database Service 4: an instance of a database that stores operational settings including license and configuration data in User Profiles in a specified global location on a network. The Global Database Service includes a web server that monitors an Administrator defined port for data traffic. User Profile data stored in 4 is copied locally to 15 during User Handset command sequences. Commands and associated Command Response status codes are returned to the Global Database Service to form an audit trail.

Managed Computer Node 5: another Managed Computer, a Node on a network connected to the Managed Computer.

Administrator Console 7: a graphical user interface that displays Alert status of Managed Computers and provides various controls (e.g., enable and disable User Handsets) as well as duplicates of controls available on User Handsets. Depending on the number of Managed Computers, a given IWNMS installation may have multiple levels of Administrator Consoles 7 displaying appropriate levels of IWNMS granularity. The Administrator Console also may display summarized audit trail data associated with each User Handset.

Master Console 12: a graphical user interface that duplicates the display and controls of multiple Administrator Consoles 7 and may provide controls not available from an Administrator Console.

Wireless Protocol Interface (WPI) 6: the target of the Managed Computer URL; displays a User Authentication prompt for the password contained in the User Profile. The WPI accepts User Handset menu selections, executes selected commands (through calls to other system components), formats User Handset response screens and generates menus for display on the User Handset.

IWNMS program files 8: executable files that implement components mentioned here (7, 10, 11, 12, 13, and 15). 8 is discussed in more detail below. The IWNMS program files check license expiration dates and other critical data at the start of each User Session.

Client Service 10: An instance of a Dynamic Content Server 14 configured as a Service to handle basic communications between the User Handset and the Managed Computer. The client service monitors an Administrator designated, secure port and dispatches an instance of the WPI 6 in response to network traffic on that port.

Server Service 11: An instance of a Dynamic Content Server 14 configured as a Service to handle basic communications requests between the Managed Computer and local or remote Managed Computers Nodes. The Server service monitors an Administrator-defined secure port and dispatches an instance of the RPC Service 16 in response to network traffic on that port. The Server Service returns command results from the RPC service to the User Handset.

RPC (Remote Procedure Call) Service: Executes commands from the Managed Computer as a remote process in a remote Managed Computer Node. The RPC service includes a Native Interface to execute RPC commands in the native operating system of the Managed Computer Node 5. The RPC returns command results from the Managed Computer Node 5 to the Managed Computer Server Service.

Notification Service 13: tests Configured Services health and Managed Computer health at Configured time intervals. Service or computer health is determined by Health Tests. If one or more Health Tests fails Configured threshold values, and the failure is confirmed by subsequent Notification Service tests, the Notification Service sends an Exception Notification (Alert message) to the User Handset that identifies the Managed Computer and/or the Managed Computer service that failed the threshold test.

Dynamic Content Server 14: Web Server that supports dynamic content and serves the Client and Server Services.

Local database 15: an instance of a database that stores User Profiles for a single Managed Computer locally on the Managed Computer. The Local Database Service may include a web server that monitors an Administrator defined port for data traffic. Command choices from the User Handset and associated Command Response status codes may be retained in the local database 15 and uploaded to the Global Database at the end of each Session.

Compiler and run-time environment 17: An instance of a compatible compiler and run-time environment to support Dynamic Content Server 14 and Program Files 8 execution requirements.

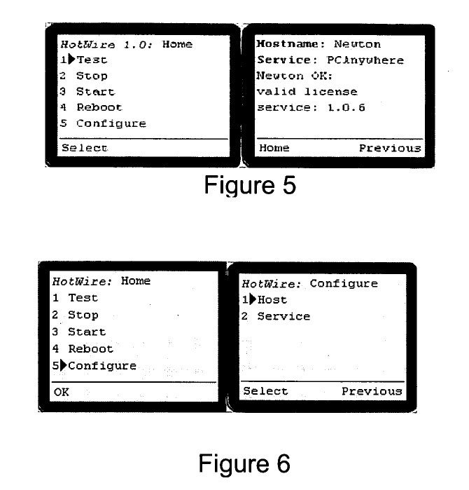

FIG. 5 is a screen shot of the 5-button User Handset interface of the IWNMS. FIG. 5 illustrates the Test Command user interface (left) and the Test Command response (right).

FIG. 6 is a screen shot of the Configure Command user interface (left) and the Configure Command Response (right) of the IWNMS.

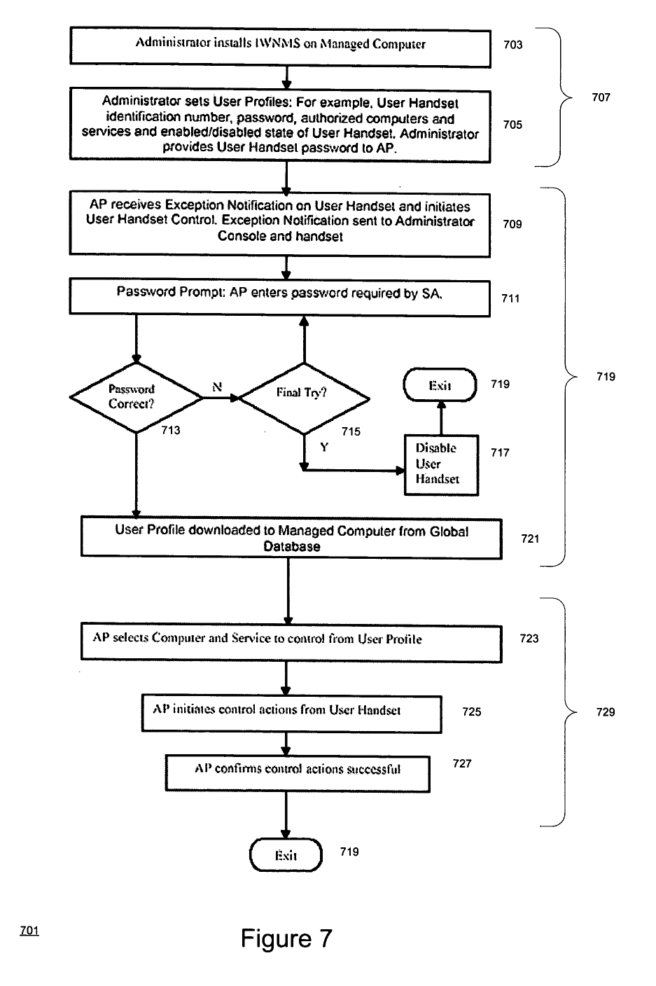

FIG. 7 is a flow chart 701 illustrating operation of the IWNMS. The first stage of the operation is the initialization 707 of the IWNMS on a managed computer 3. First, an administrator installs IWNMS on the managed computer 3 (703). Then, after the software is installed, the administrator sets user profile information (705). This can be done either during installation or from administrator console 7 any time after the installation has been completed. The user profile information set at this time includes at least enough user profile information to permit the managed computer 3 to send a message to a handset 1 and to verify a password received in a message from the handset. The administrator also provides the password to the AP who is to use the handset. The administrator may download new user profile information at any time after the IWNMS software has been installed on managed computer 3.

The next stage of the operation is the interaction 719 between handset 1 and managed computer 3 which establishes a session between handset 1 and managed computer 3. Interaction 719 begins at 709 when the AP who is in possession of handset 1 initiates handset control of managed computer 3. Step 709 may be performed in response to an exception notification message which IWNMS sends handset 1 in response to an exception which has arisen in managed computer 3. The information needed to send the exception notification message comes from the user profile information which was downloaded at step 705. Managed computer 3 also sends the exception notification to administrator console 7.

When handset 1 contacts managed computer 3, managed computer 3 operates under IWNS control to provide a password prompt to handset 1 (711). The AP then enters the password he or she received from the system administrator. If the entered password agrees with the one for the handset that was provided in step 705, the next step is step 721. Otherwise, a number of retries are permitted (715) and when the maximum number specified in the downloaded user profile information is reached, managed computer 3 sets the user profile information to indicate that handset 1 has been disabled, sends a message indicating that fact to administrator console 7 (717), and exits IWNMS.

In step 721, IWNMS downloads current user profile information for managed computer 3 and handset 1 identified by the password and identification number downloaded in step 705 from global database 4. The current user profile information specifies at least the kind of control which the AP can exercise over managed computer 3 from handset 1. Because step 721 is performed at the beginning of any session between handset 1 and managed computer 3, any change which the administrator has made prior to the downloading in global database 4 regarding the kind of control which the AP can exercise over managed computer 3 from handset 1 is effective for the session.

The final stage 729 is the interaction between handset 1 and managed computer 3 that occurs during the session established in interaction 719. Based on the current user profile information downloaded in step 721, the IWNMS software provides a menu to the handset like the ones shown in FIGS. 5 and 6. The menu lists the managed computers that the current user profile permits the AP to control and lists for each managed computer only those operations which the current user profile indicates that the AP may perform on that managed computer. The AP then selects the computer and the operation from the menu (723) and initiates the specified operation (725). Having selected and initiated the operation, the AP can then specify a test to confirm that the operation has been successful (727). Interaction 729 may be repeated for a number of different managed computers or operations. When the AP has performed all of the desired operations, the AP terminates the session. Upon termination of the session, the IWNMS software logs the results of the session and terminates. Global database 4 periodically reads the software logs and updates its user profile information as required.

In an alternate embodiment of the IWNMS, the SSH (Secure Shell) protocol is used to communicate between the User Handset 1 and the Managed Computer 3 and to encapsulate Client 10, Server 11 and RPC 16 Services.

The IWNMS is client-server software that installs on Managed Computers and on User Handsets and enables authorized user(s) to securely monitor and control remote computer services and restart Managed Computers from the User Handset within limits specified dynamically by the Administrator. (See the Glossary for specialized definitions of capitalized terms).

In the IWNMS, the process described above is used to implement bi-directional wireless communications between the User Handset, the Managed Computer and the Global Database, enabling authorized user(s) to monitor and securely control the Managed Computer, configured Network Nodes and their configured services from a User Handset within organization policy limits and Administrator defined control definitions. IWNMS communications between the User Handset, the Managed Computer and Network Nodes uses HTTPS and HTML and Extensible Markup Language (XML), but other protocols such as HTTP and STML may also be used.

In an alternative embodiment, the process described above is used to implement bi-directional wireless communications and control enabling authorized user(s) to monitor and securely control remote computer(s) and services from a User Handset within organization policy limits and Administrator defined control definitions over the Wireless Application Protocol (WAP).

As shown in FIG. 2, inexpensive User Handsets that support WAP require a WAP Gateway (provided by the WSP) to establish a connection between a User Handset and a Managed Computer. In this embodiment, the User Handset communicates to the WAP Gateway using an alternative language, Wireless Markup Language (WML) versus communicating directly to the Managed Computer in HTTPS and HTML or Extensible Markup Language (XML) as can be used with a non-WAP phone capable of browsing.

Program files: the logic required to support 1, 4, 7, 10, 11, 12, 13, and 14 is implemented in Program files 8 and the Wireless Protocol Interface 6. These components are discussed in detail below:

Wireless Protocol Interface: 6 the Client Service 10 launches WPI when the AP selects the Managed Computer URL on the User Handset 1, beginning a Session. The WPI is responsible for AP User Authentication, executing User Handset commands and displaying command results on the User Handset interface. In IWNMS, the WPI 6 displays a menu on a User Handset to an Authenticated User. (See FIG. 5: User Handset Interface).

User Interface controls: The number of controls and control meaning may be modified by a Managed Computer SA at any time by modifying the User Profile fields through the Administrator Console 7. For the following IWNMS discussion, assume that the configured User Profile specifies a User Handset interface configured with five (5) menu selections (controls): Test, Stop, Start, Reboot and Configure. These selections are sufficient to control services on a remote Managed Computer within limits established by a Managed Computer SA.

In IWNMS, computer fully qualified names and full service names are not shown on the User Handset unless an SA chooses to do so. During installation or subsequent administration through the Administrator's console, a SA chooses labels that are displayed instead. For example, if the fully qualified computer name was “sql.igsw.com”, the SA might use the label DBSvr. Similarly, the SA may use the label “DBSrvc” instead of “MSSQLServer”.

In this example, the meaning of the first four controls (Test, Stop, Start, and Reboot) is modified by the last (Configure) control. That is, if “Newton” is the configured computer label and “pcaw” the configured service label, then
Test runs basic Health Tests on Managed Computer “Newton” (See FIG. 6: User Handset Interface for the result screen (right illustration)),
Stop stops the pcaw service on computer Newton,
Start starts the pcaw service on computer Newton,
Reboot reboots computer Newton.

Configure allows the user to choose a Managed Computer (host) and managed services from choices determined by a systems Administrator (SA). Configuration changes of host and/or service are uploaded to the Global Database.

User Handset caching: many User Handsets implement command caching. That is, the User Handset keeps a record of each command it sends over the wireless link in a local cache and searches the cache for commands it is about to send. This caching procedure is meant to conserve scarce resources and improve apparent response time by not transmitting redundant commands. In the case of dynamic content, such as the one the IWNMS confronts, identical sequential commands may be required that may yield new data at each invocation. To ensure transmission of each command, redundant or not, the IWNMS defeats User Handset caching. There are several means of defeating User Handset caching; for illustrative purposes, this description assumes the technique of appending a random number to each command string sent to the User Handset to defeat caching.

Program Files 8:

WPI: Implements WPI 6. WPI performs User Authentication and executes User Handset Commands. WPI is a combination of User Authentication and User Handset command execution methods. The Dynamic Content Server 14 detects User Handset traffic and launches a WPI instance with a Request and Response Object. The Request object encapsulates HTTP/S request information contained in the User Handset traffic. The Response Object contains methods to write output to the User Handset display. WPI command execution logic consists of a Command Dispatcher and Command Execution methods. The WPI dispatcher retrieves a command name from the Request object, dispatches a method to service the command and writes command output to the User Handset using Response Object methods. Since command names and parameters are dynamic, all references to command names and parameters are resolved through a User Profile in the Local Database.

On initial WPI entry, WPI dispatches the User Authentication method. User Authentication logic is illustrated in FIG. 7. A system variable, persistent only for the current Session, is set to indicate User Authenticated status following successful User Authentication.

User Handset commands may be accepted for execution following successful User Authentication. WPI is dispatched with a command name that was selected from the User Handset User Interface. The WPI dispatcher accesses parameters passed from the User Handset to the Dynamic Content Server 14 by reference to the Request object and to the User Profiles in the Local Database. 15.

Display data returned by command methods differs for different wireless protocol transports supported by the present invention. For illustrative purposes, the balance of this section assumes the Wireless Application Protocol (WAP).

GUI: implements Administrator and Master Console User Interfaces with reference to the Global Database to distinguish functions and screens available by console type. In IWNMS, the Administrator Console may perform the same functions from the Managed Computer that the IWNMS performs from the User Handset and may perform additional functions defined by an Administrator Profile in the Global Database. A Master Profile in the Global Database defines valid Master Console functions (a superset of Administrator functions).

ITimer: a general-purpose interval (watchdog) timer that supports GUI connections. Used by multiple classes.

RPC: wraps RPC methods in a thread for independent scheduling.

Server: wraps the Server Service class, implements and schedules the RPC remote command execution class that executes command line commands on remote Managed Computer Nodes 5.

EnDecrypt: file and stream encryption and decryption methods and decryption class loader. Program files are stored in encrypted form on the Managed Computer. EnDecrypt class loaders load decrypted classes into the Run-Time environment.

GlobalDatabase: methods to access Global Database tables and data items within tables. Inserts new data items, selects and updates data items in Global Database tables.

refreshLocalDatabase: downloads User Profiles from tables in the Global Database to Local Database tables. Inserts new data items into tables, selects and updates data items in tables in the Local Database. licenseRegistration: installation support class. Inserts installation User Profile into Local Global Database tables from data gathered during installation process.

localDatabase: methods to access Local Database User Profiles (tables and data items within tables). Inserts new data items into tables, selects and updates data items in tables in the Managed Computer Local Database.

CheckSum: calculates and returns file checksums and sends notification of mismatch to designated recipients. Used by Common methods to detect data or Program file corruption and to alert the AP, the Administrator and Master Consoles if data or Program file corruption occurs. CheckSum calls the Notification Service message formatter to format a CheckSum failure Event Notification message that is immediately sent to the Notification Service for delivery to the User Handset. Also, the CheckSum failure status in the Global Database is set true, causing the Administrator and Master Consoles to indicate CheckSum failure status identifying the corrupt file name and path.

primeLocalDatabase: installation support class. Inserts new User Profile data items into tables in local database gathered during installation.

notification: Performs Health Tests of Administrator designated services and computers at Administrator designated time intervals. If the Health Test fails for a specified service or computer, and the failure is confirmed by an Administrator-specified number of repeated tests, the Notification Service notifies the user with an Event Notification, identifying the service and or computer that failed. Notification is a combination of a notification task dispatcher, routines to test configured services, a message formatter and message server. The notification task dispatcher queries the Local Database for the Managed Computer name and all configured service names, then dispatches routines to perform Health Tests of the configured computers and each of the configured services on the Managed Computer at Administrator-specified time intervals.

The Managed Computer Health Test sends network messages to the Configured Computers and notes response times. If the response time exceeds an Administrator-specified time interval, the test is counted as a failure. The Configured Service Health Test runs a native operating system routine to identify running services. If the Configured Service is not listed, the test is counted as a failure.

If a Health Test fails, the failure is confirmed by an Administrator-specified number of repeated Health Tests. If the failure is confirmed, the message formatter is called to format an Event Notification message specifying a computer or service failure. The Event Notification message (Alert) is sent to the Notification Service for delivery to the User Handset.

Common: collection of methods common to multiple classes.

1. A method whereby a first processor interacts with a second processor via a network, the method comprising the steps performed in the second processor of:
receiving a first message from the first processor;
responding thereto by fetching user profile information via the network from a remote database that is remote from the second processor; and
interacting further with the first processor as permitted by the fetched user profile information.

2. The method set forth in claim 1 wherein:
the user profile information is associated with the first processor and the second processor in the remote database.

3. The method set forth in claim 2 wherein:
in the remote database, the first processor is associated with a first identifier and the second processor is associated with a second identifier; and
the step of fetching the user profile information includes the step of providing the first and second identifiers to the remote database.

4. The method set forth in claim 2 wherein:
the identifier for the first processor includes a password; and
the password is included in the initial message.

5. The method set forth in claim 1 wherein the method further comprises the step of:
sending an exception notification to the first processor, the first message being received in response to the exception notification.

6. The method set forth in claim 1 wherein the method further comprises the step of:
sending a log derived from the interaction between the first and second processors to the remote database.

7. The method set forth in claim 1 wherein:
the network by which the first and second processors interact includes a wireless component.

8. The method set forth in claim 7 wherein:
the first processor is a handset that has access to the wireless component.

9. A data storage device, the data storage device being characterized in that:
the data storage device contains code for a program which, when executed on a processor, implements the method set forth in claim 1.

10. A method whereby a first processor interacts with a second processor via a network, the method comprising the steps performed in the first processor of:
sending a first message to the second processor; and
interacting further with the second processor as permitted by user profile information which the second processor fetches from a remote database in response to the first message, the remote database being remote to the second processor.

11. The method set forth in claim 10 wherein:
the first message includes a password, the password being used in the second processor to fetch the user profile information.

12. The method set forth in claim 10 further comprising the step of:
receiving an exception notification from the second processor, the step of sending the first message being performed in response to the exception notification.

13. The method set forth in claim 10 wherein:
the fetched user profile information determines a user interface by which a user of the first processor interacts the second processor.

14. The method set forth in claim 10 wherein:
the network by which the first and second processors interact includes a wireless component.

15. The method set forth in claim 14 wherein:
the first processor is a handset that has access to the wireless component.

16. A data storage device, the data storage device being characterized in that:
the data storage device contains code for a program which, when executed on a processor, implements the method set forth in claim 10.

17. A method whereby a first processor interacts with a second processor via a network, the method being performed in a remote database that is remote from the second processor and accessible via the network and comprising the steps of:
receiving a request for user profile information associated with the first and second processors from the second processor, the second processor sending the request in response to an initial message from the first processor; and
providing the requested user profile information to the second processor, the second processor thereupon interacting with the first processor as permitted by the provided user profile information.

18. The method set forth in claim 17 further comprising the step of:
receiving a log derived from the interaction between the first and second processors.

19. A data storage device, the data storage device being characterized in that:
the data storage device contains code for a program which, when executed on a processor, implements the method set forth in claim 17.
